(19) United States
(12) Patent Application Publication
(10) Pub. No.: US 2023/0151277 A1
(43) Pub. Date: May 18, 2023

(54) FURNACE FOR PYROLYSIS

(71) Applicant: GREEN FOREST SOLUTIONS LLP, Worksop, Nottinghamshire (GB)

(72) Inventor: Rory HUGHES, Worksop, Nottinghamshire (GB)

(21) Appl. No.: 17/915,089

(22) PCT Filed: Mar. 31, 2021
(86) PCT No.: PCT/GB2021/050808

§ 371 Date: Sep. 27, 2022

(30) Foreign Application Priority Data
Mar. 31, 2020 (GB) 2004700.7

(51) Int. Cl. C10B 1/10; B08B 9/043; B08B 9/045; C10B 11/00; C10B 5/00; C10B 53/07; C10B 7/12; F23G 5/027; F23G 5/20; F23G 7/00

(52) U.S. Cl. CPC C10B 1/10; B08B 9/0436; B08B 9/045; C10B 11/00; C10B 5/00; C10B 53/07; C10B 7/12; F23G 5/027; F23G 5/20; F23G 7/003; F23G 2201/30; F23G 2203/20; F23G 2209/281; F23G 2900/50201

(57) ABSTRACT

A rotary furnace (1) for pyrolyzing a feedstock, the furnace (1) comprises a rotating vessel (12) having an upstream end (12A) with an inlet (16) for receiving feedstock and a downstream end (12B) with an outlet (17A, 17B) for egress of pyrolysis products, and a gas extraction pipe (13) extending within and along the rotating vessel (12) from the downstream end (12B), the gas extraction pipe (13) having an opening (18) upstream of the downstream end (12B) to accept gaseous components generated in use.

This invention relates generally to a furnace for the pyrolysis of feedstock. More specifically, although not exclusively, this invention relates to the extraction of volatile components from a furnace during a pyrolytic reaction and a method of performing the same.

Furnaces or kilns may be stationary or rotary. Rotary furnaces or kilns are devices that may be used for the pyrolysis of feedstock. Pyrolysis is defined as the thermal decomposition of materials at elevated temperatures in the absence of oxygen. The pyrolysis of organic materials produces volatile components as well as a carbon-rich solid char, which represent useful and often renewable fuel sources. In general, rotary furnaces comprise a rotating cylindrical vessel in which the feedstock is heated to effect pyrolysis.

It is estimated that approximately 1.5 billion tyres are produced each year (P. T. Williams, Waste Management, vol. 33, 8, 1714-1728, 2013). These tyres will eventually enter the waste stream, which is a major problem for waste and environmental pollution. It is common for scrap tyres to be disposed of in landfill. However, this is inefficient because tyres are bulky and have a large amount of void space and, because of their inherent resilience, can be difficult to compact. In the past, scrap tyres have been disposed of by burning in the open air. However, this leads to the production of highly toxic substances that are damaging to human health such as polyaromatic hydrocarbons including benzene, styrene, butadiene, and phenol-like substances. Consequently, burning tyres in the UK is now illegal. Scrap tyres may be dealt with at an incineration plant. However, this leads to the generation of environmentally polluting gases and greenhouse gases such as SOₓ, NOₓ, CO₂ and CO.

It is known to pyrolyze waste tyre material. Pyrolysis of waste tyres is an attractive option for tackling the problem of waste tyre material whilst allowing energy and materials recovery. This process degrades the tyre material into fuel gas, oils, solid residue (char), and low-grade carbon black. During the reaction, the rubber is softened and the rubber polymers degrade into smaller molecules to form a vapour. These vapours can be burned directly to produce power or condensed into an oily type liquid, generally used as a fuel. Some molecules are too small to condense. These remain as a gas which can be burned as fuel. The solid material such as minerals that formed the remaining tyre material (about 40% by weight) may be removed as solid ash.

Advantageously, when performed correctly, this process does not produce those harmful gases that are often produced during incineration. Therefore, pyrolysis of waste tyre material represents an effective process for converting a space-consuming waste product into new and clean energy.

The volatile fractions recovered during pyrolysis are a valuable fuel source. However, it remains a challenge to efficiently capture or collect these materials. It is therefore a first non-exclusive object of the invention to provide an apparatus and method for more effectively and cleanly recovering the gaseous components produced during a pyrolytic reaction, for example, the pyrolysis of waste tyre material.

Accordingly, a first aspect of the invention provides a rotary furnace for pyrolyzing a feedstock, the furnace comprising a rotating vessel having an upstream end with an inlet for receiving feedstock and a downstream end with an outlet for egress of pyrolysis products, and a gas extraction pipe extending within and along the rotating vessel from the downstream end, the gas extraction pipe having an opening upstream of the downstream end to accept gaseous components generated in use.

It has been surprisingly found that removing gaseous components generated during pyrolysis at a location within the rotary furnace which is upstream of the downstream end of the rotating vessel is advantageous because the amount of particulates in the removed vapour is limited or reduced in comparison with removal of the gaseous components at other locations within the rotating vessel.

The rotary furnace may be used for the pyrolysis of any suitable feedstock that is able to thermally decompose into pyrolysis products. In embodiments, the feedstock may be a rubber-based material, for example, automotive tyre material. The tyre material may be shredded or crumb, for example shredded tyre material and/or tyre crumb. In alternative embodiments, the feedstock may be other rubber wastes or biomass waste. In alternative embodiments, the feedstock may be industrial plastic waste.

The feedstock may have a maximum size of 10 to 0.4 mm (0.4 inches to 0.0165 inches or 40 US mesh).

In embodiments, the rotating vessel may be inclined at an angle. The rotating vessel may slope downwards from the upstream end to the downstream end such that, in use, the upstream end is at a greater distance from the ground than the downstream end. In embodiments, the rotating vessel may be inclined at an angle of between 1, 2, 3 or 4 to 15 degrees relative to the longitudinal horizontal axis, for example between 5 to 14 degrees, 6 to 13 degrees, 7 to 12 degrees, 8 to 11 degrees, or 9 degrees to 10 degrees. In embodiments, the rotating vessel may be inclined at an angle of 1, 2, 3, 4, 5, 6, 7, 8, 9, 10, 11, 12, 13, 14, or 15 degrees. In embodiments we prefer that the angle of inclination is above 5 degrees, for example from 6 to 10 degrees.

Advantageously, when the rotating vessel slopes downwards from the upstream end to the downstream end, the feedstock may be conveyed along the rotating vessel from the inlet to the outlet under the influence of gravity.

In embodiments, the gas extraction pipe extends less than half way along the length of the rotating vessel, for example between 0.15 times to less than 0.50 times the length of the rotating vessel, e.g. between 0.20 to less than 0.45 times the length of the rotating vessel, or between 0.25 to 0.40 times the length of the rotating vessel, or between 0.30 to 0.35 times the length of the rotating vessel.

In embodiments, the ratio of the internal diameter (or other maximum transverse dimension) of the rotating vessel to the internal diameter (or other maximum transverse dimension) of the gas extraction pipe is between 2:1 to 5:1, for example, 2.5:1, or 3:1, or 3.5:1 or 4:1 or 4.5:1.

In embodiments, the internal diameter (or other maximum transverse dimension) of the rotating vessel is between 500 to 1100 mm, e.g. between 600 or 700 to 1000 mm, or between 800 to 900 mm, or between 800 to 900 mm, or between 825 to 900 mm. In embodiments, the internal diameter (or other maximum transverse dimension) of the gas extraction pipe is between 200 to 500 mm, e.g. between 250 to 450 mm, or between 300 to 400 mm, e.g. between 300 to 350 mm or between 350 to 400 mm.

In embodiments, the longitudinal axis of the gas extraction pipe is parallel to and (e.g. vertically) offset from the longitudinal axis of the rotating vessel. The gas extraction pipe may be located in the upper portion of the rotating vessel, in use.

Advantageously, the location of the gas extraction pipe in the upper portion of the rotating vessel, wherein the longitudinal axis of the gas extraction pipe is parallel to and (e.g. vertically) offset from the longitudinal axis of the rotating vessel, enables the gaseous components to be extracted as these volatilise from the pyrolysis mixture, whilst providing a headspace above the material to be pyrolyzed and/or to ensure that solid material does not enter (or at least is less likely to enter) and thereby foul the opening of the gas extraction pipe.

In embodiments, the gas extraction pipe comprises a chamfered inlet for entry of gaseous components generated in use. The end of the pipe may be inclined to the longitudinal axis of the extraction pipe. The degree of inclination may be from 15 to 45°. In an embodiment the degree of inclination may be from 20 to 40°, say 25 to 35°. In a embodiment the angle of inclination is 30°. By having an inclined inlet the pipe presents a relatively larger inlet to gases, than if the inlet to the pipe extended orthogonally to the longitudinal axis of the pipe. We believe that a chamfered or inclined inlet enables more effective entry of gaseous components generated in use by providing a larger surface area for the egress of gas from the rotating vessel. The inlet may taper towards the downstream end of the furnace from top to bottom of the extraction pipe. In addition, there is less fowling caused by solid char.

In embodiments, rotating vessel is configured to rotate at a speed of between 1 to 20 rpm, say 1 to 15 rpm, for example, 1 to 10 rpm. In an embodiment the speed of rotation may be 2 to 8 rpm.

In embodiments, the gas extraction pipe may remain static as the rotating vessel rotates. The gas extraction pipe may be translatable, i.e. may be movable in a direction parallel to the longitudinal axis of the rotating vessel, said translation may occur before, during or after operation of the rotating vessel. The gas extraction pipe may be mounted within a member which comprises a bearing to allow the rotating vessel to rotate thereabouts.

In embodiments, the rotating furnace may comprise a hopper for receiving feedstock. The hopper may comprise a wide opening for receiving feedstock, for example, for continuously receiving feedstock.

In embodiments, the rotating furnace may comprise a feeding means to convey feedstock to the inlet of the rotating vessel. In embodiments, the rotating furnace may comprise a feeding means to convey feedstock from the hopper to the inlet of the rotating vessel. In embodiments, the feeding means may comprise a conduit comprising an auger conveyor extending therethrough. In embodiments, the auger conveyor may be driven by an electrical motor.

In embodiments, the rotating vessel may comprise a first outlet for the removal of gaseous components and a second outlet for the removal of solid pyrolytic products, for example, solid char.

In embodiments, the rotary furnace may comprise a gas condensation chamber. The gas condensation chamber may comprise an inlet for receiving gaseous components from the rotating vessel. The gas condensation chamber may comprise an outlet for removing condensed gaseous components from the gas condensation chamber.

In embodiments, the gas extraction pipe may comprise a self-cleaning device configured to contact an interior surface of the gas extraction pipe to remove debris therefrom.

In embodiments, the longitudinal axis of the gas extraction pipe may be parallel to and (e.g. vertically) offset from the longitudinal axis of the rotating vessel, and additionally the gas extraction pipe may comprise a self-cleaning device configured to contact an interior surface of the gas extraction pipe to remove debris therefrom. Advantageously, in these embodiments, the location of the gas extraction pipe within the rotating vessel ensures that solid material is less likely to enter the opening of the gas extraction pipe. However, if solid material does enter the gas extraction pipe then the self-cleaning device is able to contact an interior surface of the gas extraction pipe to remove the debris therefrom. Therefore, these features function together to ensure that the gas extraction pipe remains clear from debris when the rotary furnace is in use, which makes the gas extraction (and hence the pyrolysis operation) more efficient, leading to cleanly recovered gaseous components.

A second aspect of the invention provides a rotary furnace for the pyrolysis of a feedstock, the rotary furnace comprising a combustion chamber and a take-off pipe for gaseous products, a translatable and/or rotatable cleaning means being providing for cleaning the internal surfaces of the take-off pipe.

The following statements apply to any aspect of the invention.

In embodiments, the cleaning means or self-cleaning device comprises a disc having a diameter (or other maximum transverse dimension) similar to, e.g. slightly less than or substantially equal to, the internal diameter (or other maximum transverse dimension) of the gas extraction pipe. In embodiments, the cleaning means or self-cleaning device comprises a circular disc having a diameter similar to, e.g. slightly less than or substantially equal to the internal diameter of the gas extraction pipe.

In embodiments, the disc is secured to a rod axially extending along the gas extraction pipe. In embodiments, the rod of the self-cleaning device is configured rotate about its axis. In embodiments, the rod of the self-cleaning device is configured to translate in a direction along its axis.

In embodiments, the rest position of the disc of the self-cleaning device may be a position in which at least a portion of the self-cleaning device extends beyond the opening of the gas extraction pipe. In embodiments, the disc of the self-cleaning device may be configured to extend beyond the opening of the gas extraction pipe.

Advantageously, the cleaning means or self-cleaning device prevents the gas extraction pipe from becoming blocked with solid pyrolysis products. More advantageously, the rotary furnace does not require disassembly to clean the gas extraction pipe.

The cleaning means or self-cleaning device may be operable according to a pre-set program. For example the cleaning means or self-cleaning device may be operable to clean an internal surface of the take-off pipe periodically, after a certain amount of feedstock material has been processed and/or after a certain amount of solid and/or vaporous products have been generated. Operation of the cleaning means or self-cleaning device may involve causing the cleaning means or self-cleaning device to translate along and/or rotate within the take off pipe. Operation of the cleaning means or self-cleaning device may comprise causing the cleaning means or self-cleaning device t translate along and/or rotate within the take-off pipe a number of times and then rest for a period of time. Additionally or alternatively, operation of the cleaning means or self-cleaning device may occur after a batch of materials has been processed, at the end of a shift, and the end of a day, week, month etc.

A further aspect of the invention provides a rotary furnace for the pyrolysis of a feedstock, the rotary furnace comprising a combustion chamber and a take off pipe for gaseous products, a translatable and/or rotatable cleaning means being providing for cleaning the internal surfaces of the take off pipe.

A further aspect of the invention provides a method of pyrolyzing feedstock in a rotary furnace, the method comprising:
a. providing a rotary furnace according to any preceding claim;
b. locating feedstock at the inlet;
c. conveying the feedstock through the rotating vessel;
d. pyrolyzing the feedstock to produce gaseous components;
e. removing the gaseous components from the rotating vessel via the gas extraction pipe.

The method may comprise adding feedstock to a hopper, where present. The method may comprise conveying the feedstock from the hopper to the inlet of the rotating vessel. The method may comprise conveying the feedstock from the hopper to the inlet of the rotating vessel via a conduit having an auger conveyor.

The method may comprise conveying the feedstock through the rotating vessel from an upstream end to a downstream end by means of gravity.

In embodiments, the method may comprise heating the rotating vessel to a temperature of between 300 to 1200° C., for example, between 400 to 1100° C., or between 500 to 100° C., or between 600 to 900° C., or between 700 to 800° C. to effect pyrolysis of the feedstock.

In embodiments, the method may comprise pyrolyzing the feedstock in the rotating vessel for a residence time of between 30 and 90 minutes, say from 45 to 75 minutes.

In embodiments, the feedstock may be a rubber-based material, for example, waste tyre material. In embodiments, the feedstock may be shredded tyre material and/or tyre crumb, or mixtures thereof.

Advantageously, the apparatus and method according to the invention provide an efficient way to recycle feedstock, for example, waste tyre material, to produce energy-rich fuel sources.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

Embodiments of the invention will now be described by way of example only with reference to the accompanying drawings in which:

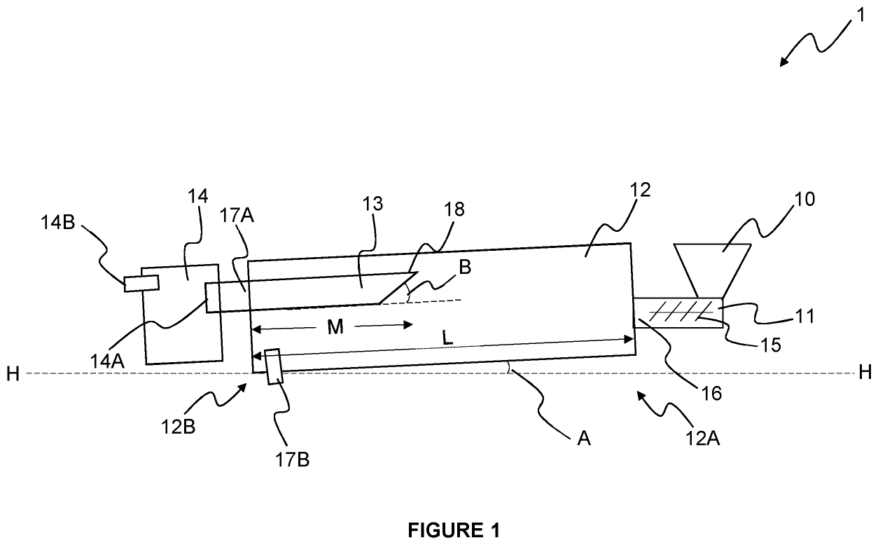

FIG. 1 is a cross-sectional view of the side elevation of a rotary furnace according to an embodiment of the invention;

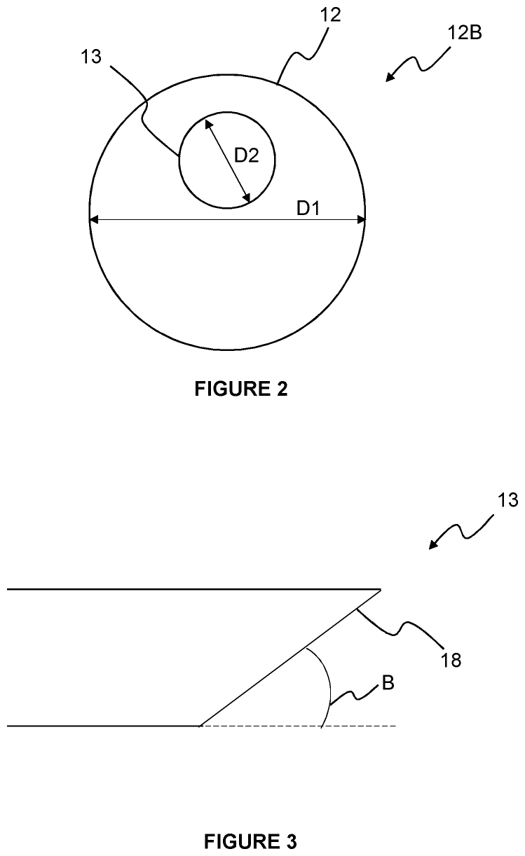

FIG. 2 is a cross-sectional view of the rear elevation of the downstream end of the rotating vessel of the rotary furnace of FIG. 1;

FIG. 3 is the opening of the gas extraction pipe of the rotary furnace of FIG. 1;

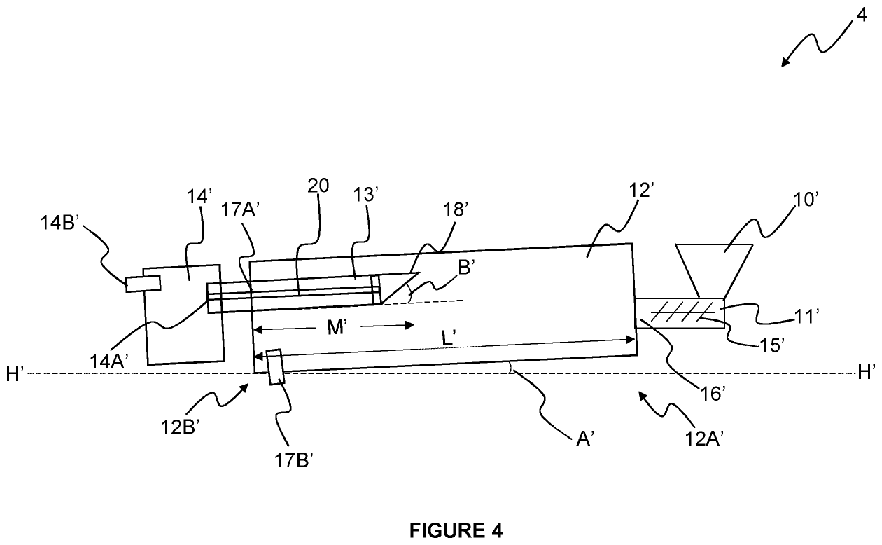

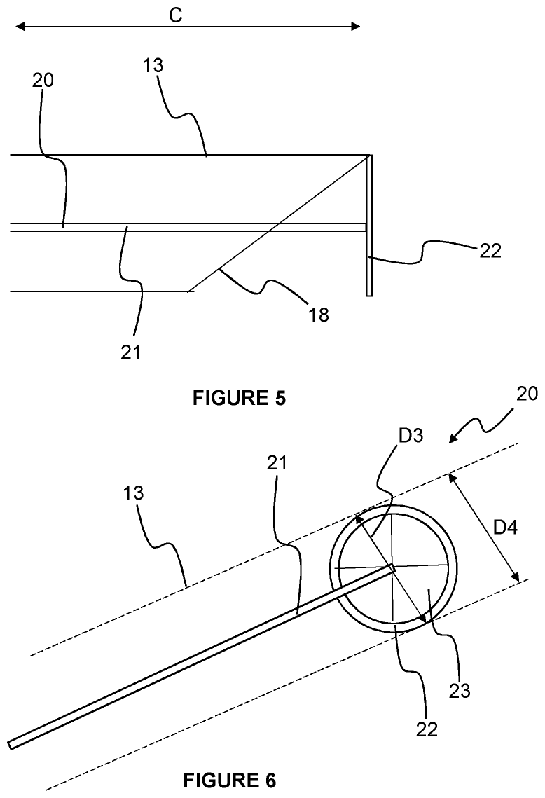

FIG. 4 is a cross-sectional view of the side elevation of a rotary furnace comprising a self-cleaning device, according to a further embodiment of the invention FIG. 5 is a side elevation of the self-cleaning device shown in FIG. 4;

FIG. 6 is a three dimensional representation of the self-cleaning device shown in FIGS. 4 and 5.

Referring now to FIG. 1, there is shown a cross-sectional view of the side elevation of a rotary furnace 1 for pyrolyzing a feedstock according to a first embodiment of the invention.

The rotary furnace 1 comprises a hopper 10, a conduit 11, a rotating vessel 12, a gas extraction pipe 13, and a gas condensation chamber 14. The conduit 11 comprises an auger conveyor 15 extending therethrough. The rotary furnace 1 further comprises a heating means (not shown) to elevate the temperature of the feedstock to effect pyrolysis.

The rotating vessel 12 has an upstream end 12A and a downstream end 12B. The upstream end 12A has an inlet 16 for receiving feedstock. The downstream end 12B has a first outlet 17A and a second outlet 17B for the egress of pyrolysis products. In this embodiment, the first outlet 17A is configured for the egress of gaseous components, and the second outlet 17B is configured for the egress of solid products such as char.

The gas extraction pipe 13 comprises an opening 18. The gas extraction pipe 13 extends within and along the rotating vessel 12 from the downstream end 12B. The opening 18 is upstream of the downstream end 12B of the rotating vessel 12.

The gas condensation chamber 14 comprises an inlet 14A and an outlet 14B.

In this embodiment, the rotating vessel 12 is inclined at an angle A of between 4 to 15 degrees relative to the longitudinal horizontal axis H.

In this embodiment, the gas extraction pipe 13 extends less than half way along the length L of the rotating vessel 12. The gas extraction pipe 13 extends within and along the rotating vessel 12 by a length M. In this embodiment, the length L of the rotating vessel 12 is approximately 7 metres and the length M is between 2.5 to 3.0 metres, e.g. 2.8 metres, such that the gas extraction pipe 13 extends into the rotating vessel 12 by a length M that is 0.4 times the length L of the rotating vessel 12.

It has been surprisingly found that extracting gaseous components from the rotary furnace of the invention is most effective if the opening 18 of the gas extraction pipe 13 is located at a length M that is 0.4 times the length L of the rotating vessel, for example 2.8 metres to 2.9 metres from the downstream end 12B of a 7 metre long rotating vessel 12. Without wishing to be bound by any particular theory, it is thought that extracting the gaseous components at this location minimises the volume of suspended carbon particles in the volatile gas.

The longitudinal axis of the gas extraction pipe 13 is parallel to and vertically offset from the longitudinal axis of the rotating vessel 12.

Referring also to FIG. 2, there is shown a cross-sectional view of the rear elevation of the downstream end 12B of the rotating vessel 12 of the rotary furnace 1 of FIG. 1. In this embodiment, the rotating vessel 12 and the gas extraction pipe 13 are substantially cylindrical. The ratio of the internal diameter D1 of the rotating vessel 12 to the internal diameter D2 of the gas extraction pipe 13 is between 2:1 to 4:1, for example, 3:1, or 2.5:1. In an embodiment, rotating vessel 12 has a diameter of 810 mm and the gas extraction pipe 13 has a diameter of 320 mm, such that the ratio of the internal diameter of the rotating vessel 12 to the internal diameter of the gas extraction pipe 13 is approximately 2.5:1.

Referring also to FIG. 3, there is shown the opening 18 of the gas extraction pipe 13 of the rotary furnace 1 of FIG. 1. In this embodiment, the opening 18 comprises a chamfered inlet. The angle B created by the chamfered inlet of the opening 18 may be between 20 to 40 degrees, for example, 30 degrees.

Referring to FIGS. 1 to 3, the hopper 10 comprises a wide opening for receiving portions of the feedstock. In combination, the conduit 11 and the auger conveyor 18 define a feeding means, which is configured to convey feedstock from the hopper 10 to the inlet 16 of the rotating vessel 12. In this embodiment, the auger conveyor 15 is driven by an electrical motor (not shown).

The rotary vessel 12 is configured to rotate about its longitudinal axis during pyrolysis of the feedstock, for example, at a speed of between 1 to 10 rpm. The rotary vessel 12 comprises a gear system (not shown) to effect rotation whilst the remaining components of the rotary furnace 1 including the gas extraction pipe 13 remain static.

The gas extraction pipe 13 is configured to accept gaseous components generated in use of the rotary furnace 1 during a pyrolytic reaction. The opening 18 of the gas extraction pipe 13 is in communication with the inlet 14A of the gas condensation chamber 14. The gas condensation chamber 14 is configured to condense the volatile, gaseous components that enter from the outlet 17A of the gas extraction pipe 13.

In use, feedstock is loaded into the hopper 10 as a batch or continuously. The feedstock is conveyed from the hopper 10 through the conduit 11 by action of the auger conveyor 15. The feedstock enters the rotating vessel 12 through the inlet 16. The feedstock is heated to temperature suitable for pyrolysis. The rotating vessel 12 rotates about its longitudinal axis to mix the feedstock as it thermally degrades into pyrolysis products comprising gaseous components and solid char. Advantageously, the rotating vessel 12 slopes downwards from the upstream end 12A to the downstream end 12B to enable, in use, the feedstock to be conveyed along the rotating vessel 12 from the inlet 16 to the outlet 17 under the influence of gravity.

The gaseous components flow from the rotating vessel 12 through the opening 18 of the gas extraction pipe 13. Advantageously, the opening 18 being a chamfered inlet enables more effective entry of gaseous components generated in use by providing a larger surface area for the egress of gas from the rotating vessel 12 to the gas condensation chamber 14. In addition, there is less fowling caused by solid char.

The gaseous components flow through the gas extraction pipe 13, through the outlet 17A of the rotating vessel 12, and into the inlet 14A of the gas condensation chamber 14. In the gas condensation chamber 14, the gaseous components condense, and are collected through the outlet 14B.

The solid pyrolysis products, for example solid char, is collected from the rotating cylinder 12 via the second outlet 17B.

The feedstock may be tyre crumb. The rotary furnace 1 may be used to pyrolyze tyre crumb into solid char and gaseous components.

Referring now to FIG. 4, there is shown a cross-sectional view of the side elevation of a rotary furnace 4 for pyrolyzing a feedstock according to a further embodiment of the invention. The rotary furnace 4 shares many of the same features, which function in the same manner, as the rotary furnace 1 shown in FIG. 1. These features are labelled with the same reference numeral as that shown in FIG. 1 with an additional a prime (′).

The gas extraction pipe 13′ of the rotary furnace 4 further comprises a self-cleaning device 20.

Referring also to FIG. 5, there is shown a side elevation of the self-cleaning device 20 of FIG. 4 in more detail. Referring also to FIG. 6, there is shown the self-cleaning device 20 in a three dimensional view. The self-cleaning device 20 comprises a rod 21 and a circular disc 22. The circular disc 22 comprises a cut-out portion 23 such that air and other gaseous compounds are able to flow therethrough. The rod 21 is secured to the centre of the circular disc 22.

The self-cleaning device 20 is configured to contact at least a portion of the interior surface of the gas extraction pipe 13. The circular disc 22 comprises an outer diameter D3. The gas extraction pipe 13 comprises an internal diameter D4. The outer diameter D3 of the circular disc 22 is substantially equal to the internal diameter D4 of the gas extraction pipe 13.

The rod 21 is dimensioned to axially extend longitudinally through the length of the gas extraction pipe 13. The rod 21 is configured rotate about its axis and/or to translate in a direction along its axis.

The self-cleaning device 20 may have a rest position when not in use. As shown in FIG. 5, the circular disc 22 of the self-cleaning device 20 is configured to extend beyond the opening 18 of the gas extraction pipe 13.

The self-cleaning device 20 functions to remove built-up dirt and debris from the gas extraction pipe 13′ after the pyrolysis reaction has finished. Advantageously, this prevents the gas extraction pipe 13 from becoming blocked with solid pyrolysis products. More advantageously, the rotary furnace 4 does not require disassembly to clean the gas extraction pipe.

The self-cleaning device 20 may also be retro-fitted into the rotary furnace 1 of FIG. 1 to produce the rotary furnace of FIG. 4.

Advantageously, the apparatus and method according to the invention provide an efficient way to recycle feedstock, for example, waste tyre material, to produce energy-rich fuel sources. More advantageously, the apparatus enables the gaseous components of the pyrolysis products to be more efficiently recovered for use as a fuel. In addition, the self-cleaning device enables the apparatus to be kept clean and debris free such that it is able to operate efficiently, without having to dismantle the apparatus after use.

It will be appreciated by those skilled in the art that several variations to the aforementioned embodiments are envisaged without departing from the scope of the invention.

It will also be appreciated by those skilled in the art that any number of combinations of the aforementioned features and/or those shown in the appended drawings provide clear advantages over the prior art and are therefore within the scope of the invention described herein.

1. A rotary furnace for pyrolyzing a feedstock, the furnace comprising a rotating vessel having an upstream end with an inlet for receiving feedstock and a downstream end with an outlet for egress of pyrolysis products, and a gas extraction pipe extending within and along the rotating vessel from the downstream end, the gas extraction pipe having an opening upstream of the downstream end to accept gaseous components generated in use.

2. A rotary furnace according to claim 1, wherein the rotating vessel is inclined at an angle of between-4 to 15 degrees relative to the longitudinal horizontal axis.

3. A rotary furnace according to claim 1, wherein the gas extraction pipe extends less than half way along the length of the rotating vessel.

4. A rotary furnace according to claim 1, wherein the ratio of the internal width of the rotating vessel to the internal width of the gas extraction pipe is 2:1 to 4:1.

5. A rotary furnace according to claim 1, wherein the longitudinal axis of the gas extraction pipe is parallel to and offset from the longitudinal axis of the rotating vessel.

6. A rotary furnace according to claim 1, wherein the gas extraction pipe comprises a chamfered inlet for entry of gaseous components generated in use.

7. A rotary furnace according to claim 6, wherein the angle created by the chamfered inlet is 20 to 40 degrees.

8. A rotary furnace according to claim 1, wherein the rotating vessel is configured to rotate at a speed of 1 to 10 rpm.

9. A rotary kiln according to claim 1, wherein the gas extraction pipe comprises a self-cleaning device configured to contact an interior surface of the gas extraction pipe to remove debris therefrom.

10. A rotary furnace according to claim 9, wherein the self-cleaning device comprises a disc having a width substantially equal to the internal width of the gas extraction pipe.

11. A rotary furnace according to claim 10, wherein the self-cleaning device comprises a circular disc having a diameter substantially equal to the internal diameter of the gas extraction pipe.

12. A rotary furnace according to claim 10, wherein the disc is secured to a rod axially extending through the gas extraction pipe.

13. A rotary furnace according to claim 12, wherein the rod of the self-cleaning device is configured rotate about its axis.

14. A rotary furnace according to claim 12, wherein the rod of the self-cleaning device is configured to translate along its axis.

15. A rotary furnace according to claim 10, wherein the disc of the self-cleaning device is configured to extend beyond the opening of the gas extraction pipe.

16. A rotary furnace according to claim 1, further comprising a hopper.

17. A rotary furnace according to claim 1, further comprising a feeder.

18. A rotary furnace according to claim 1, further comprising a gas condensation chamber.

19. A rotary furnace according to claim 1, wherein the outlet for egress of pyrolysis products comprises a first outlet for the egress of gaseous components and a second outlet for the egress of solid pyrolysis products.

20. A method of pyrolyzing feedstock in a rotary furnace, the method comprising:
a. providing a rotary furnace according to claim 1;
b. locating feedstock at the inlet;
c. conveying the feedstock through the rotating vessel;
d. pyrolyzing the feedstock to produce gaseous components;
e. removing the gaseous components from the rotating vessel via the gas extraction pipe.
